(19) United States
(12) Patent Application Publication
(10) Pub. No.: US 2019/0234880 A1
(43) Pub. Date: Aug. 1, 2019

(54) METHOD OF ESTABLISHING IMAGE ANALYSIS ALGORITHM FOR MICROWELL ARRAY

(71) Applicant: INDUSTRY-UNIVERSITY COOPERATION FOUNDATION SOGANG UNIVERSITY, Seoul (KR)

(72) Inventors: Bong Geun CHUNG, Gyeonggi-do (KR); Hirak MAZUMDAR, Seoul (KR); Tae Hyeon KIM, Seoul (KR); Jong Min LEE, Seoul (KR)

(21) Appl. No.: 16/237,249

(22) Filed: Dec. 31, 2018

(30) Foreign Application Priority Data
Jan. 30, 2018 (KR) 10-2018-0011116

(51) Int. Cl. G01N 21/64; G06K 9/62; G06T 5/00

(52) U.S. Cl. CPC G01N 21/6456; G06T 5/002; G01N 21/6452; G06K 9/6269

(57) ABSTRACT

A method of analyzing an image of a microwell array on which objects influenced by fluorescent treatment are dispensed, comprises obtaining an image of wells of the microwell array, obtaining labeling information that classifies the wells of the microwell array into filled wells, partially filled wells, and unfilled wells, firstly classifying some or all of the wells of the microwell array into the filled wells, the partially filled wells and the unfilled wells by using the obtained image and the labeling information, and secondly classifying the partially filled wells into the filled wells or the unfilled wells through differential evolution algorithm.

### CROSS-REFERENCE TO RELATED APPLICATION(S)

This application claims the benefit under 35 USC § 119(a) of Korean Patent Application No. 10-2018-0011116 filed on Jan. 30, 2018 in the Korean Intellectual Property Office, the entire disclosures of which are incorporated herein by reference for all purposes.

### TECHNICAL FIELD

The present invention relates to an automatic image analysis targeted to a microwell, more particularly, relates to a method of establishing an image analysis algorithm of a microwell array that can quickly and stably perform an image analysis of a microwell.

### BACKGROUND

In general, the density of micro-sized objects is measured through a microscope, and the count and the density of the objects can be calculated using an existing image recognition program or by manually calculated with a high labor intensity.

However, the conventional methods require well-defined sample shapes and sizes, and the biological samples often have poorly defined shapes and sizes. In the case of deviating from a predefined shape, the calculations are often not available by a conventional algorithm.

In order to solve this problem, increasing the tolerance of the image recognition program could partially solve the problem, but it results in increasing the false identification of the particles, which greatly increases the confidence interval of the measurement.

To analyze a microwell array, the following conditions must be met: (1) the size of all wells must be the same, and (2) the distance between wells must be constant. Also, (3) the wells must clearly belong to the rows and columns of the array. (4) The wells are preferably circular, and (5) there is no contamination in the image of the sample. However, even if all the conditions are met, it is still difficult to extract three-dimensional information from two dimensional image.

Conventionally, in the method of image analysis for microwells, the wells of a sample are divided into two groups, such as positive and negative, by classifying the fluorescence signal of each individual well and the presence of wells in the sample can be determined based on the classification. In order to classify the wells, a threshold value is set by a certain method. In some cases, a microwell close to a threshold does not belong to a positive or negative group. In some cases, a classification result can be reversed. These wells are perceived as undifferentiated wells, which reduces the accuracy of the overall well classification.

In the Computerized Medical Imaging and Graphics 36 (2012) journal, “FPGA based system for automatic microarray image processing” (Bogdan Belean et al.), disclosed is a method of performing pixel analysis using a shock filter for automatic analysis of DNA microarrays. However, this is not perfect in that it uses only the brightness of the image.

### Technical Subjects

The present invention provides a method of establishing an image analysis algorithm of a microwell array which can overcome the difficulty of classifying near-threshold values and automatically classify the microwell array with high accuracy.

### SUMMARY

According to a preferred embodiment of the present invention for achieving the subject described above, a method of analyzing an image of a microwell array on which objects influenced by fluorescent treatment are dispensed, comprises obtaining an image of wells of the microwell array, obtaining labeling information that classifies the wells of the microwell array into filled wells, partially filled wells, and unfilled wells, firstly classifying some or all of the wells of the microwell array into the filled wells, the partially filled wells and the unfilled wells by using the obtained image and the labeling information, and secondly classifying the partially filled wells into the filled wells or the unfilled wells through differential evolution algorithm.

In the step of obtaining the label information, fluorescence intensity for each of the wells may be specified from the obtained image related to every pixel. When the ratio of the pixels having a predetermined threshold intensity or more in a well is greater than or equal to the upper limit ratio, the well having the pixels can be classified into the filled wells, otherwise when the ratio of the pixels having a predetermined threshold intensity or more in a well is less than or equal to the lower limit ratio, the well can be classified into the unfilled wells.

The upper limit ratio may be selected in the range of 70% to 90%, preferably around 80%, and the lower limit ratio may be selected in the range of 10 to 30%, preferably around 20%. The predetermined threshold intensity may be determined based on fluorescence intensity at a pixel or pixels around a boundary of the image of the unfilled wells.

The partially filled wells may be analyzed by using a support vector machine (SVM) in the step of the second classification. Of course, the SVM may be applied when obtaining the labeling or the first classification.

The differential evolution algorithm may be designed to stop after 90 to 120 iterations in the step of the second classification, and the analysis using the SVM may be performed using a plurality of intensity and texture functions or a plurality of Zemike moments as elements.

For example, the plurality of intensity and texture functions include at least one of an average intensity, an average color channel, a standard deviation, an average gray level, an average contrast, a smoothness, a moment, and an entropy. Preferably, if all the functions mentioned the above are used, the better result can be gotten. Also, the analysis using the SVM may be performed by using at least two Zemike moments as elements.

The second classification may comprise a reclassifying step of targeting the wells classified as the partially filled wells, and the reclassifying step may apply a Gaussian filter to the partially filled wells and classify the partially filled wells into the filled wells or the unfilled wells based on a predetermined reclassification threshold.

According to a preferred embodiment of the present invention for achieving the subject described above, a method of analyzing an image of a microwell array on which objects are dispensed, comprises obtaining labeling information that classifies the wells of the microwell array into a plurality of categories, firstly classifying the wells of the microwell array based on the categories, and secondly classifying of performing a learning algorithm on the wells belonging to one category among the categories classified by the first classification step and classifying them into other categories except the one category.

In the present embodiment, the objects may be distinguished in two or more categories, which are specified optically or chemically even if they are not labeled with a fluorescent material. The labeling information can be obtained by analyzing some of the microwell array in real time, or be already memorized or set. And the first classification may be performed to some or all of the microwell array.

Besides, in the present invention, the wells of the microwell array are intended to be classified into at least two categories, and the number of the categories defined or used in the present embodiment may be at least three.

Differential evolution algorithm may be used in the second classification, in which the differential evolution algorithm may be designed to stop after 90 to 120 iterations.

In the second classification, the one category of the wells may be analyzed by using a support vector machine (SVM), and the analysis using the SVM may be performed by using a plurality of intensity and texture functions or a plurality of Zernike moments as elements.

According to the analysis method of the present invention, a method based on SVM can be presented for an accurate and simple classification from the image of a microwell array.

According to the present invention, the wells of the microwell array can be classified into three categories, such as filled wells, unfilled wells, and partially filled wells, in the first classification, and the partially filled wells can be reclassified into the filled wells or the unfilled well in the second classification.

To improve the quality of the classification, 17 functions may be used, however actually 10 functions can provide a good result by using the machine learning approach. The method proposed by the present invention may be useful particularly when analyzing microwell data containing a lot of noises, and may be useful for other image analysis methods.

### BRIEF DESCRIPTION OF DRAWINGS

FIG. 1 and FIG. 2 are views of a microwell array for explaining an analysis method for image analysis of a microwell array according to an embodiment of the present invention.

FIG. 3 is a view of illustrating a process of dispensing objects to a microwell array for explaining an analysis method for image analysis of a microwell array according to an embodiment of the present invention.

FIG. 4 is a view for explaining an actual example of a microwell array for explaining an analysis method for image analysis of a microwell array according to an embodiment of the present invention.

FIG. 5 is a view for explaining a microwell array analyzing apparatus for explaining an analyzing method for image analysis of a microwell array according to an embodiment of the present invention.

FIG. 6 is a view of illustrating a labeling step in an analysis method for image analysis of a microwell array according to an exemplary embodiment of the present invention.

FIG. 7 is a view for explaining a process of analyzing wells using a support vector machine in an analysis method for image analysis of a microwell array according to an embodiment of the present invention.

FIG. 8 is a flow chart for explaining classification steps in an analysis method for image analysis of a microwell array according to an embodiment of the present invention.

FIG. 9 is a flow chart for explaining differential evolution algorithm in an analysis method for image analysis of a microwell array according to an embodiment of the present invention.

FIG. 10 is a photograph for explaining a microwell array in a classification step in an analysis method for image analysis of a microwell array according to an embodiment of the present invention.

FIG. 11 is a view for explaining a table and a confusion matrix for comparing results in a labeling process and a learning process in an analysis method for image analysis of a microwell array according to an embodiment of the present invention.

FIG. 12 is a graph for explaining accuracy according to the number of features selected in the analysis method for image analysis of a microwell array according to an embodiment of the present invention.

FIG. 13 is a graph for explaining accuracy according to the number of times of the differential evolution algorithm in the analysis method for image analysis of the microwell array according to an embodiment of the present invention.

FIG. 14 is a graph for explaining the number of wells in a labeling process, a training process, and a classification process in an analysis method for image analysis of a microwell array according to an embodiment of the present invention.

FIG. 15 is a graph of pixel intensities classified into nine levels by applying a Gaussian filter for reclassification in an analysis method for image analysis of a microwell array according to an embodiment of the present invention.

FIG. 16 is a graph of the number of wells according to percentages in partially filled wells in an assay method for image analysis of a microwell array in accordance with an embodiment of the present invention.

FIG. 17 is a table showing results of reclassification in an analysis method for image analysis of a microwell array according to an embodiment of the present invention.

### DETAILED DESCRIPTION

Hereinafter, embodiments of the present invention will be described in detail with reference to the accompanying drawings, but the present invention is not limited or restricted to the embodiments. For reference, in the description, like reference numerals substantially refer to like elements, which may be described by citing contents disclosed in other drawings under such a rule and contents determined to be apparent to those skilled in the art or repeated may be omitted.

Preparation

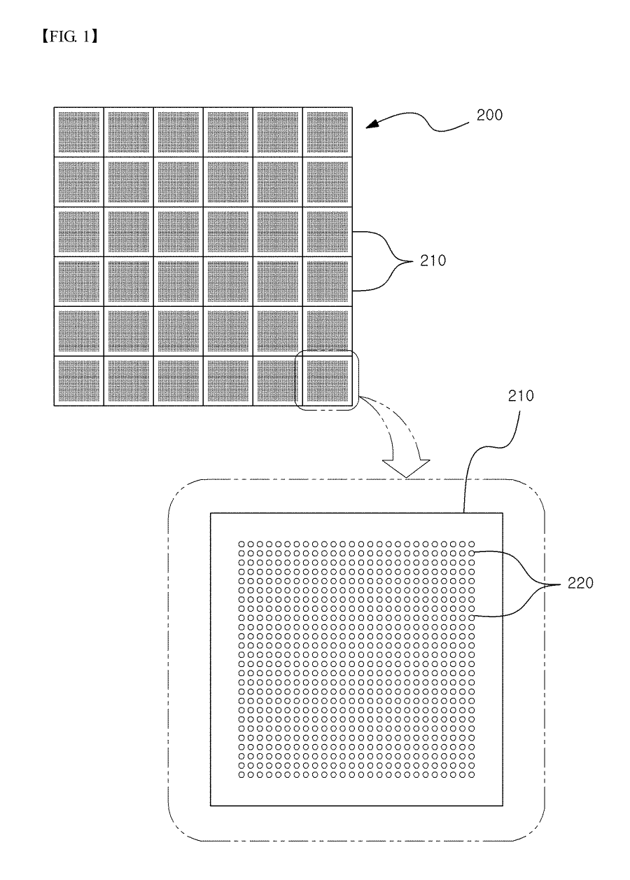

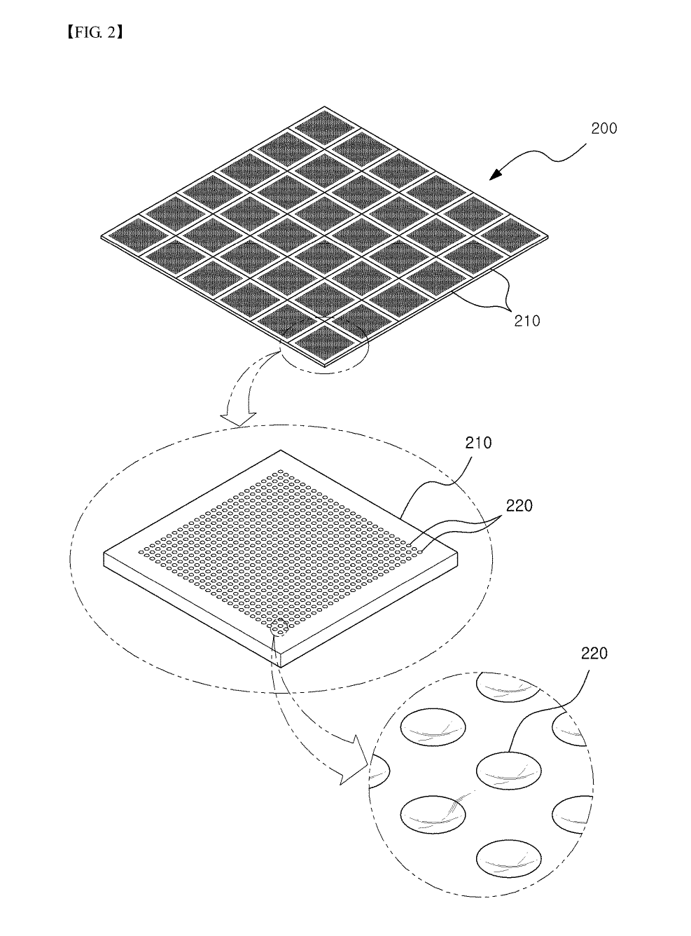

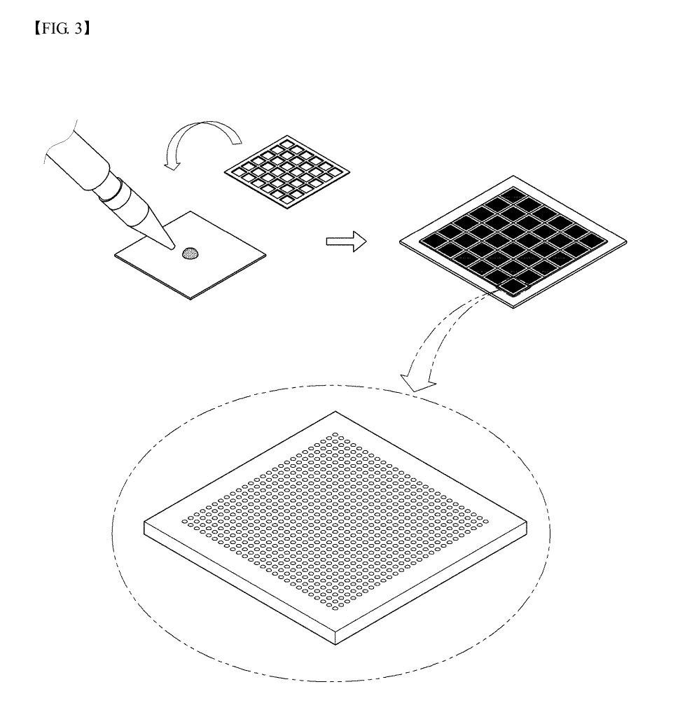

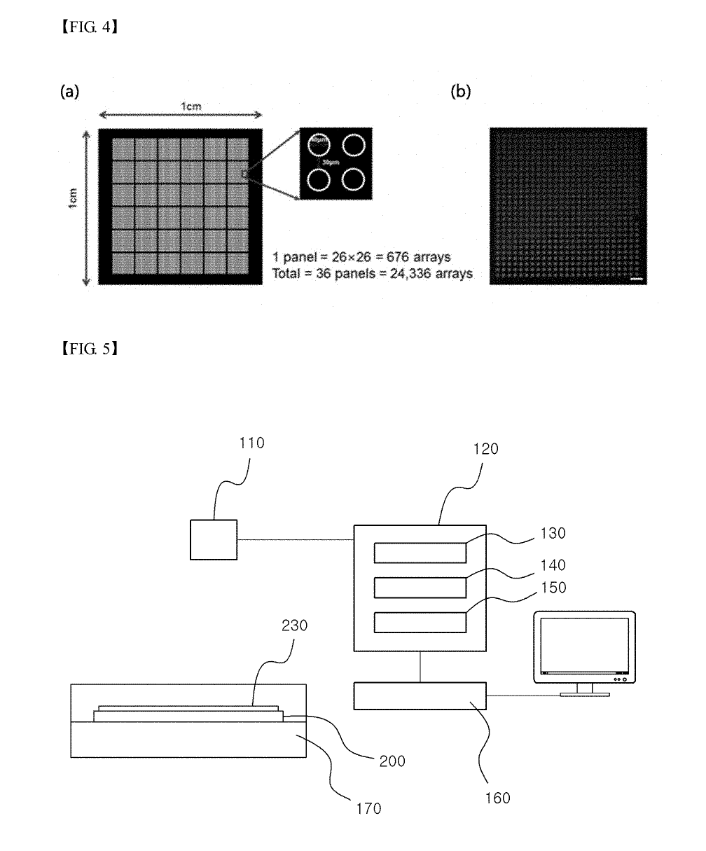

FIG. 1 and FIG. 2 is a view of a microwell array for explaining an analysis method for image analysis of a microwell array according to an embodiment of the present invention, FIG. 3 is a view of illustrating a process of dispensing objects to a microwell array for explaining an analysis method for image analysis of a microwell array according to an embodiment of the present invention, FIG. 4 is a view for explaining an actual example of a microwell array for explaining an analysis method for image analysis of a microwell array according to an embodiment of the present invention, and FIG. 5 is a view for explaining a microwell array analyzing apparatus for explaining an analyzing method for image analysis of a microwell array according to an embodiment of the present invention.

Referring to FIGS. 1 to 4, the microwell array 200 according to the present embodiment may be formed using PDMS material and may be manufactured through a soft lithography process.

At first, to create the microwell array 200, an array design can be created using a design program such as AutoCAD, and the array design can be transferred to a transparent film mask.

Specifically, after the SU8-50 is spin-coated onto a silicon wafer and irradiated with ultraviolet light (UV) through the film mask represented by the design, the silicon master can be completed using the SU-8 developer. In this manufacturing, PDMS was poured into the silicon master and cured in an oven at about 85 V for about 1 hour. The PDMS was carefully stripped from the individual devices which were cut and separated together with the silicon master by using a scalpel or surgical knife.

The microwell array 200 may be surface-treated in an oxygen plasma for approximately one minute to reduce the hydrophobicity of the PDMS.

In this embodiment, 26×26 wells 220, namely total 676 wells compose one panel 210, and one microwell array 200 has 36 panels 610, which are arranged by 6×6 on one array, therefore a total of 24,336 wells are formed on a single microwell array. In here, a diameter and a depth of each well are around 40 μm respectively, an interval between the wells is about 30 μm, and the entire area of the microwell array covers approximately 1 cm².

As shown in FIG. 3, the microwell array 200 may be placed on a glass substrate on which a FITC fluorescent solution is pipetted, and a negative pressure may be applied to fix it on the glass substrate. The fluorescent solution can be isolated into each well to be used to get fluorescent image through a microscope. In some cases, the substrate and the array can be placed in a vacuum chamber for about one minute to remove air trapped in some of the wells of the microwell array 200. The microscope slide 230 may be placed on the well arrangement to shield it from the exterior in a covered state.

In this embodiment, a FITC fluorescent solution is used for fluorescent labeling, but in other cases, a solution containing fluorescently-labeled polystyrene particles or silica-coated magnetic particles may be used. In addition, a cell culture consisting of fluorescently labeled HeLa may be used, and the inclusion of a substance that reacts to a specific light or light other than fluorescence may be used for labeling.

Referring to FIG. 5, the analysis apparatus 100 according to the present embodiment includes a camera 110 for obtaining an original image of a microwell array and a microwell classifying unit 120 for classifying the objects in the original image into a filled well FW, a partially filled well PW, and an unfilled well UW.

Labeling

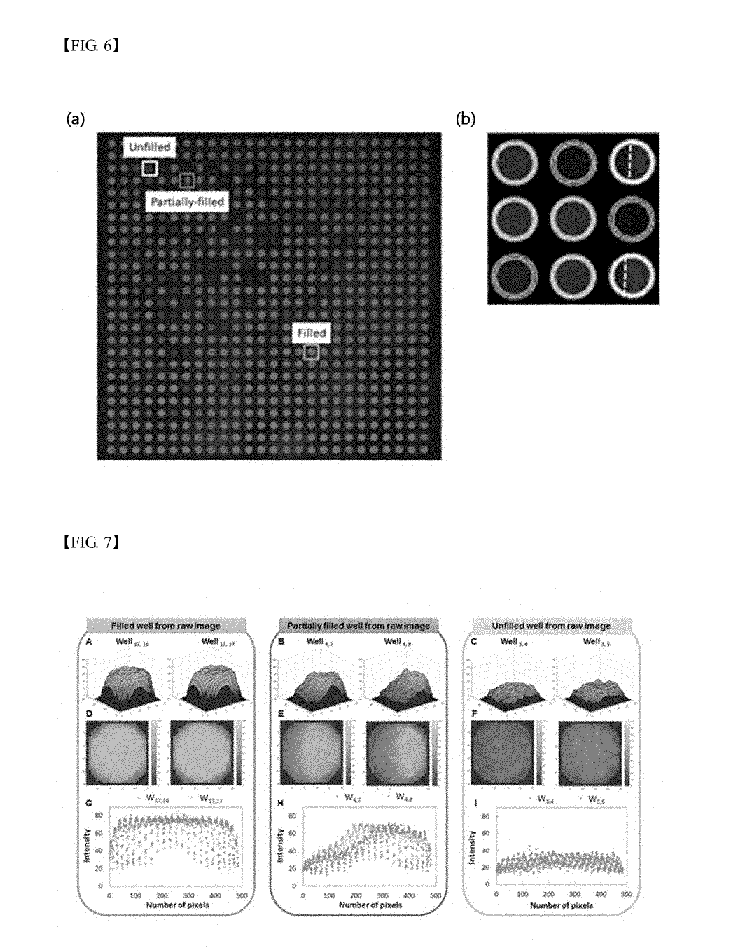

FIG. 6 is a view of illustrating a labeling step in an analysis method for image analysis of a microwell array according to an exemplary embodiment of the present invention.

Referring to FIG. 6, an image can be used that includes all of the filled well FW, the partially filled well PW, and the unfilled well UW. The partially filled well PW may be understood to be a well having both of filled region and unfilled region at the same time, wherein the partially filled wells PW are represented by yellow circles, the filled wells FW are represented by green circles, and the unfilled wells UW are represented by red circles.

FIG. 7 is a view for explaining a process of analyzing wells using a support vector machine in an analysis method for image analysis of a microwell array according to an embodiment of the present invention.

Referring to FIG. 7, in order to obtain labeling information, each of the well 220 may have three-dimensional distributions (A to C) of pixel intensities, two-dimensional graphs (D to F) of pixel image, and pixel intensity graphs (G to I), relating to the filled wells FW, the partially filled wells PW and the unfilled wells UW.

It may be very important to define labels to different categories of SVM to improve classification accuracy or performance. In the case of this embodiment, the wells can be classified into three classes such as the filled well FW, the partially filled well PW, and the unfilled well UW in the first classification step. For the first classification, the partially filled well PW can be defined by the ratio of the number of pixels of intensity exceeding the predetermined threshold to the total number of pixels. To do this, we can refer to an image with all three categories.

In the partially filled well PW, a boundary virtually dividing the bright pixel region and dark pixel region can be defined, and the critical intensity can be determined to be about 40 by observing the fluorescence intensity at the virtually defined boundary. When more than about 80% of the pixels in each well 220 are above the critical intensity 40, the well 220 can be classified as the filled well (FW), and less than 20% of pixels are above the critical intensity 40, the well 220 can be classified as the unfilled well (UW). Other remaining wells can be classified as the partially filled well PW and be subjected to the second classification step.

Classification

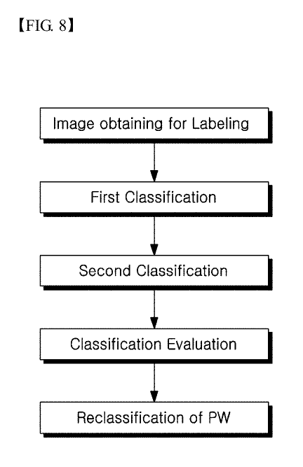

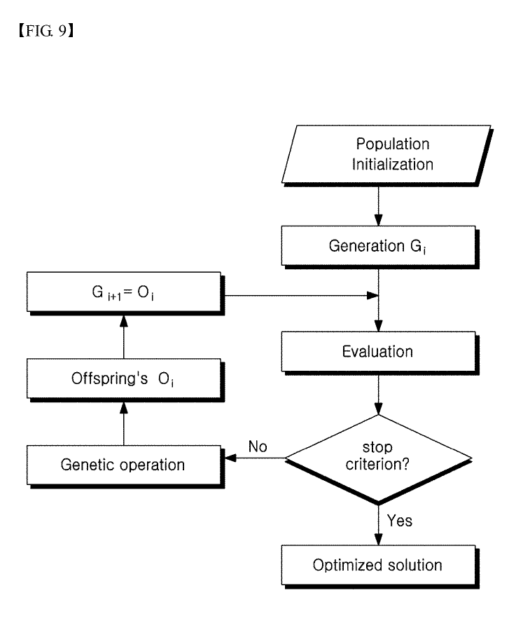

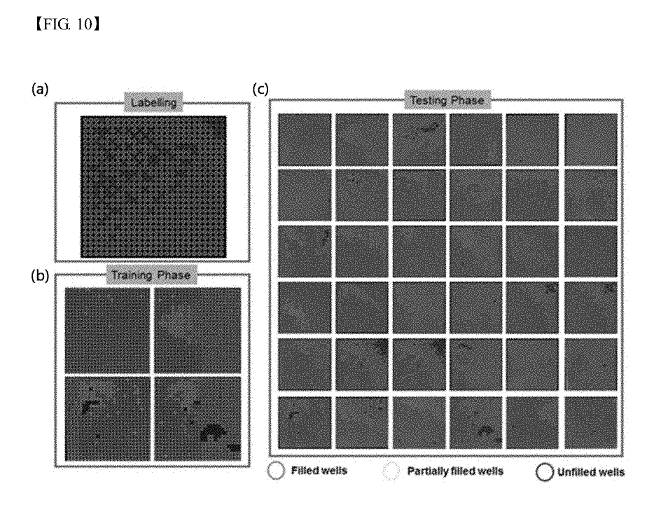

FIG. 8 is a flow chart for explaining classification steps in an analysis method for image analysis of a microwell array according to an embodiment of the present invention, FIG. 9 is a flow chart for explaining differential evolution algorithm in an analysis method for image analysis of a microwell array according to an embodiment of the present invention, and FIG. 10 is a photograph for explaining a microwell array in a classification step in an analysis method for image analysis of a microwell array according to an embodiment of the present invention.

Referring to FIGS. 8 to 10, the classification step according to the present embodiment may include an image obtaining for labeling, a first classification, a second classification, a classification evaluation and a reclassification of PW. Once, as shown in FIG. 10, an image of the panel can be used for labeling, and training or learning operation can be performed using only some portion of the image, for example using 4 panel's images, and, after the training or learning, the classification can be on the entire well using the labeling information obtained through the learning.

Firstly, in the first classification, the well 220 of the microwell array 200 can be classified into the filled wells FW, the partially filled wells PW, the unfilled wells UW. Then, the second classification may be performed in which the partially filled wells PW are again subjected to a new classification to re-classify them into the filled wells and the unfilled wells.

The two-stage of classifications can provide higher accuracy than the prior art, the present invention can be useful for judging the fluorescence signal in various biosensors, and can be applied to a variety of biological applications.

Specifically, in the second classification step, a fluorescence image was analyzed by using Matlab's SVM (Support Vector Machine), and nine of intensity and texture functions can be extracted in the first trial. In addition, Zernike moment, which is related to the shape, can be extracted to be used to figure out the shape and the size of the wells. By using the Zernike moment, a circle having a diameter smaller than the diameter of the actual well can be defined, and the data obtained only in the circle can be selectively extracted to reduce the noise found predominantly at the boundary of the well.

Referring to FIG. 9, in the Generation Gi process, a data chromosome(serial) can be generated, and an accuracy can be retrieved through evaluation. If the conditions are met according to the evaluation result, it can be considered that the data chromosome at that time is an optimized combination. In the present embodiment, the algorithm is stopped after about 100 iterations. The chromosome algorithm can be defined as an optimized combination.

If the evaluation result does not meet the criterion, the new data chromosome can be recombined in the genetic operation. A new chromosome can be defined as offspring and input it as generation Gi (Gi+1=Oi).

Referring to FIG. 10 (c), the entire array can be classified using the SVM based on the features selected in the secondary classification step. Specifically, an array of size n×17 can be generated in the data collection step. In here, n is the number of microwells and 17 is the total number of functions for specifying each well and can be composed of 9 intensities and texture functions and 8 Zernike moments.

And differential evolution algorithm can be used to optimize the number of functions and computation time. Differential Evolution Algorithm is a kind of genetic algorithm and it is necessary to design the stopping criterion or condition of data chromosome and algorithm.

A vector composed of 17 values representing the characteristics of each well 220 can be selected as a data chromosome and the stopping criterion can be set such that the algorithm is stopped after about 100 iterations.

The data chromosome used in this embodiment can be changed in a manner of 0 or 1, 1 means to use the characteristic, and 0 means not to use. Evaluation using a differential evolution algorithm was repeated for all data chromosomes in all generations. In this process, 4 images were arbitrarily selected to extract data chromosomes for a total of 2,704 wells 220.

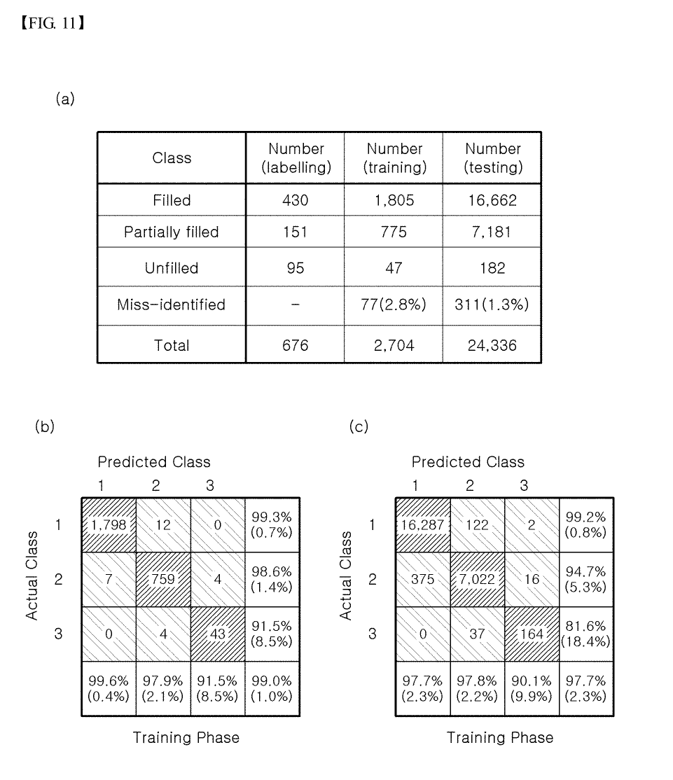

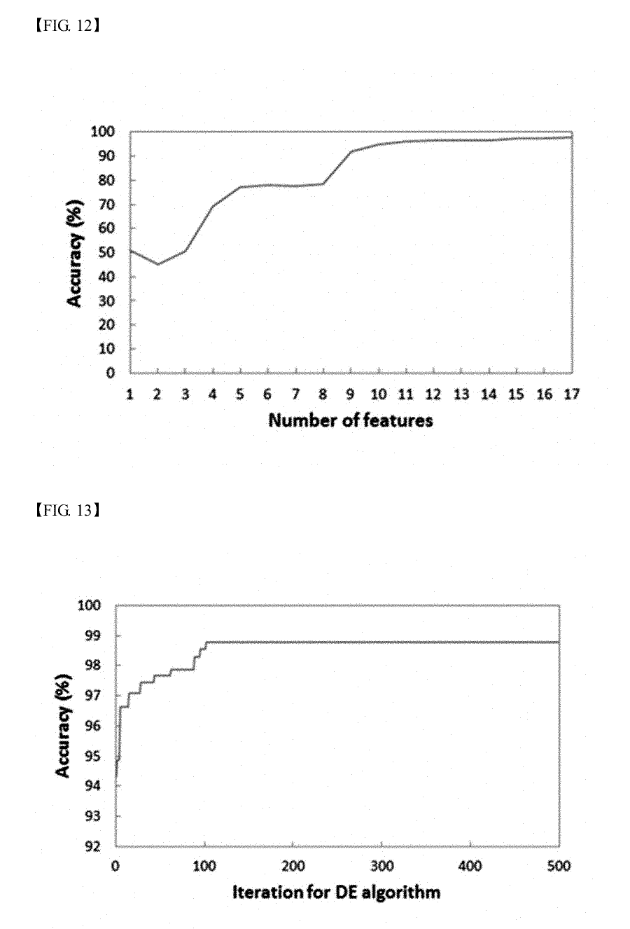

FIG. 11 is a view for explaining a table and a confusion matrix for comparing results in a labeling process and a learning process in an analysis method for image analysis of a microwell array according to an embodiment of the present invention, FIG. 12 is a graph for explaining accuracy according to the number of features selected in the analysis method for image analysis of a microwell array according to an embodiment of the present invention, and FIG. 13 is a graph for explaining accuracy according to the number of times of the differential evolution algorithm in the analysis method for image analysis of the microwell array according to an embodiment of the present invention.

Referring to FIG. 11, the SVM can classify objects not only by pre-memorized values for classification, but also by pattern recognition newly learned on label images. This leads to the recognition of additional parameters for well classification in addition to the fluorescence intensity value of the well. The performance of this SVM can be evaluated by calculating the accuracy from the confusion matrix that provides the actual classification and prediction results. The diagonal elements of the confusion matrix correspond to cases where the actual and predicted are the same, and the elements that deviate from the diagonal elements correspond to cases where the prediction differs from the actual. Thus, the accuracy can be defined as the sum of the diagonal components of the matrix divided by the sum of all components. In our case, we confirmed that the accuracy was 99% in the learning process and 97.7% in the actual classification process.

Referring to FIG. 12, the accuracy can be checked while increasing the number of features among a total of 17 features. As the number of features increases, the accuracy increases on the whole, but approximately 9 to 12 features are enough to increase the accuracy up to more than 90%.

All the microwells 220 of the array are classified into three categories based on the label image and the functions recognized in the previous step. In the classification process, only the ten functions optimized through the differential evolution process can be used. For example, the ten functions used are the average intensity, the average tone channel, the standard deviation, the average gray level, the average contrast, the smoothness, the moment, the entropy and the two Zernike moments.

Referring to FIG. 13, the differential evolution algorithm repeats a specific recovery algorithm and then to stop the recovery algorithm. As a result, when the number of iterations of the differential evolution algorithm was about 90˜120 times, the accuracy was almost saturated, and the increasing tendency of accuracy was remarkably decreased.

Therefore, in this embodiment, a vector composed of 17 values representing the characteristics of each well 220 can be selected as a data chromosome, and the stopping criterion can be set such that the algorithm is repeated about 100 times and then stopped. A vector composed of 17 values representing the characteristics of each well 220 can be selected as a data chromosome and the stopping criterion can be set such that the algorithm is stopped after about 100 iterations.

Reclassification

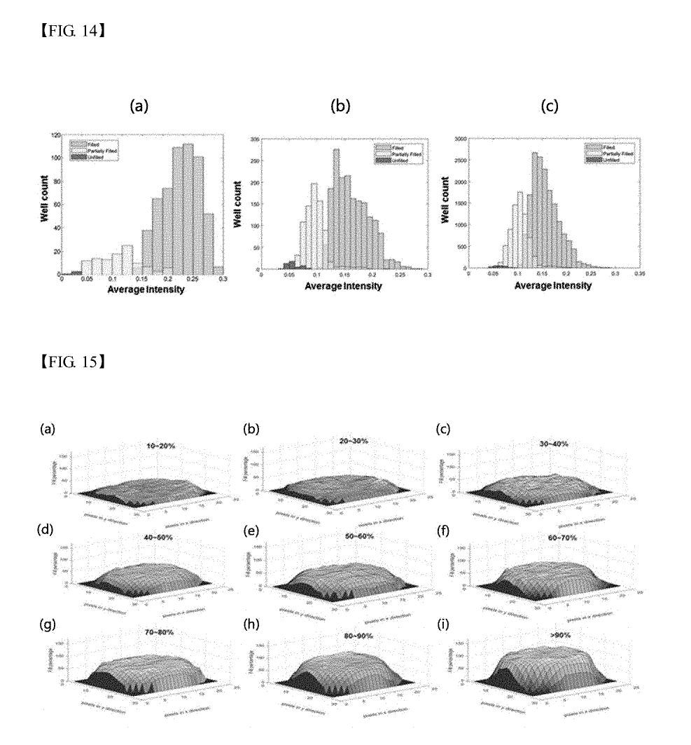

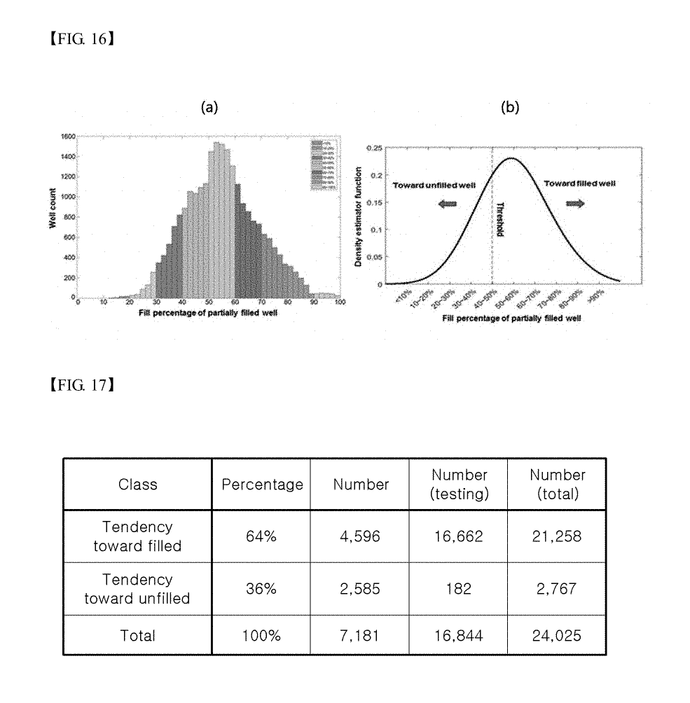

FIG. 14 is a graph for explaining the number of wells in a labeling process, a training process, and a classification process in an analysis method for image analysis of a microwell array according to an embodiment of the present invention, FIG. 15 is a graph of pixel intensities classified into nine levels by applying a Gaussian filter for reclassification in an analysis method for image analysis of a microwell array according to an embodiment of the present invention, FIG. 16 is a graph of the number of wells according to percentages in partially filled wells in an assay method for image analysis of a microwell array in accordance with an embodiment of the present invention, and FIG. 17 is a table showing results of reclassification in an analysis method for image analysis of a microwell array according to an embodiment of the present invention.

Referring to FIGS. 14 to 17, the partially filled wells among the three categories can be reclassified into two categories, such as the filled wells and the unfilled wells. In the histogram showing the number of microwells in each category according to the average fluorescence intensity of the microwells, it can be found that the partially filled well overlaps with the filled wells and the unfilled wells (see FIG. 14).

As shown in FIG. 16, a Gaussian filter may be applied to the partially filled wells to divide them into 10 different groups according to the average intensity value, and the number of wells according to the fluorescence intensity value may be represented by a histogram. By dividing the reclassification threshold by 50%, as shown in the results, 64% of the partially filled wells are considered to be filled, and remaining 36% can be classified as unfilled.

The present invention provides an SVM-based method for accurate, simple, and rapid classification of microwell array data. This method is categorized into three categories such as the filled well, the unfilled well and the partially filled well in the first classification, and the partially filled wells are classified again into two categories according to the tendency to be filled or unfilled in the second classification. In this embodiment, 17 functions can be used to improve the accuracy and the performance of the classification and can determine that 10 of these functions may be mainly related to classification using the machine learning approach. The method proposed by the present invention may be particularly useful when analyzing microwell data containing a lot of noise and may be useful for other image analysis methods.

As described above, the present invention has been described with reference to the embodiments of the present invention. However, it will be appreciated by those skilled in the art that various modifications and changes of the present invention can be made without departing from the spirit and the scope of the present invention which are defined in the appended patent claims.

### DESCRIPTION OF REFERENCE NUMERALS

100: analysis unit
110: camera
120: microwell classification unit
200: microwell array
210: panel
220: well

What is claimed is:

1. A method of analyzing an image of a microwell array on which objects influenced by fluorescent treatment are dispensed, the method comprising:
obtaining an image of wells of the microwell array;
obtaining labeling information that classifies the wells of the microwell array into filled wells, partially filled wells, and unfilled wells;
firstly classifying some or all of the wells of the microwell array into the filled wells, the partially filled wells and the unfilled wells by using the obtained image and the labeling information; and
secondly classifying the partially filled wells into the filled wells or the unfilled wells through differential evolution algorithm.

2. The method of claim 1, in the step of obtaining the label information, wherein fluorescence intensity for each of the wells is specified from the obtained image related to every pixel, when the ratio of the pixels having a predetermined threshold intensity or more is greater than or equal to the upper limit, the well is classified in the filled wells, or when the ratio of the pixels having a predetermined threshold intensity or more is less than or equal to the lower limit, the well is classified in the unfilled wells.

3. The method of claim 2, wherein the upper limit is selected in the range of 70% to 90%, and the lower limit is selected in the range of 10 to 30%.

4. The method of claim 2, wherein the predetermined threshold intensity is determined based on fluorescence intensity at a pixel corresponding to a boundary of the image of the unfilled wells.

5. The method of claim 1, wherein the partially filled wells are analyzed by using a support vector machine (SVM) in the step of the second classification.

6. The method of claim 5, wherein the differential evolution algorithm is designed to stop after 90 to 120 iterations in the step of the second classification.

7. The method of claim 5, wherein the analysis using the SVM is performed using a plurality of intensity and texture functions or a plurality of Zernike moments as elements.

8. The method of claim 7, wherein the plurality of intensity and texture functions include at least one of an average intensity, an average color channel, a standard deviation, an average gray level, an average contrast, a smoothness, a moment, and an entropy.

9. The method of claim 7, wherein the analysis using the SVM is performed by using at least two Zemike moments as elements.

10. The method of claim 1, wherein the second classification comprises a reclassifying step of targeting the wells classified as the partially filled wells, and
wherein the reclassifying step applies a Gaussian filter to the partially filled wells and classifies the partially filled wells into the filled wells or the unfilled wells based on a predetermined reclassification threshold.

11. A method of analyzing an image of a microwell array on which objects are dispensed, the method comprising:
obtaining labeling information that classifies the wells of the microwell array into a plurality of categories;
firstly classifying the wells of the microwell array based on the categories;
secondly classifying of performing a learning algorithm on the wells belonging to one category among the categories classified by the first classification step and classifying them into other categories except the one category.

12. The method of claim 11, wherein the number of the categories of the first classification is at least three.

13. The method of claim 11, wherein differential evolution algorithm is used in the second classification, in which the differential evolution algorithm is designed to stop after 90 to 120 iterations.

14. The method of claim 11, wherein the well of the one category are analyzed by using a support vector machine (SVM) in the step of the second classification.

15. The method of claim 14, wherein the analysis using the SVM is performed using a plurality of intensity and texture functions or a plurality of Zernike moments as elements.

16. The method of claim 15, wherein the plurality of intensity and texture functions include at least one of an average intensity, an average color channel, a standard deviation, an average gray level, an average contrast, a smoothness, a moment, and an entropy.

17. The method of claim 15, wherein the analysis using the SVM is performed by using at least two Zernike moments as elements.

18. The method of claim 11, wherein the second classification comprises a reclassifying step of targeting the wells classified as the one category, and
wherein the reclassifying step applies a Gaussian filter to the one category of the wells and classifies them into other categories based on a predetermined reclassification threshold.
